(19) United States
(12) Patent Application Publication
(10) Pub. No.: US 2011/0170613 A1
(43) Pub. Date: Jul. 14, 2011

(54) DIGITAL BROADCAST REPRODUCTION DEVICE AND DIGITAL BROADCAST REPRODUCTION METHOD

(76) Inventor: Yoshiteru Tanaka, Kanagawa (JP)

(21) Appl. No.: 13/056,033

(22) PCT Filed: May 19, 2009
(86) PCT No.: PCT/JP2009/002201

§ 371 Date: Mar. 1, 2011

(30) Foreign Application Priority Data
Jul. 30, 2008 (JP) 2008-196596

(51) Int. Cl. H04N 7/26

(52) U.S. Cl. 375/240.25; 375/E07.027

(57) ABSTRACT

A digital broadcast playing device (1) includes: decode units (3, 10) each configured to decode received digital broadcast stream data to generate digital broadcast frame data and output specification time data; delay time calculation units (6, 13) each configured to calculate a delay time by which the output-enabled time of the digital broadcast frame is delayed from the output specification time data; a maximum delay time holding unit (8) configured to hold, as maximum delay time, a maximum value of the delay time and the previously calculated delay time; and output timing control units (4, 11) each configured to control the output timing of the digital broadcast. Each of the output timing control units (4, 11) controls the output timing so that the digital broadcast frame is outputted after being delayed by the maximum delay time from the output specification time. Thereby, it is possible to provide a digital broadcast playing device capable of performing control to suitably delay the output timing of the digital broadcast.

### TECHNICAL FIELD

The present invention relates to a digital broadcast reproduction device (digital broadcast playing device) having a function of decoding stream data of digital broadcast and outputting the decoded stream data.

### BACKGROUND ART

In recent years, digital broadcast has been started. In the digital broadcast, each broadcast station converts encoded video and audio streams into a stream of a TS (Transport Stream) format and distributes the converted stream. A digital broadcast playing device divides the received stream of the TS format into a video stream and an audio stream, and applies decode processing to each of the video stream and the audio stream to thereby generate video and audio frames. Then, the digital broadcast playing device respectively outputs the generated video and audio frames on a screen and from a loudspeaker.

In the digital broadcast, a STC (System Time Clock) representing a reference time of the system is distributed for use in the control of the AV output timing in the digital broadcast playing device. Also in the digital broadcast, a PTS (Presentation Time Stamp) representing the time corresponding to the STC is associated with each of the video and audio frames and is distributed through each of the video stream (video PES) and the audio stream (audio PES).

Meanwhile, in the digital broadcast playing device in recent years, for the purpose of achieving multiple functionality and enhancing AV quality, video post-processing, such as image quality enhancement processing and image synthesis processing, tends to be applied to the video frame, and audio post-processing, such as sound quality enhancement processing and sound synthesis processing, tends to be applied to the audio frame.

However, there is a large difference between the execution time of the video post-processing and the execution time of the audio post-processing. Thus, in order to achieve lip synchronization, delay control to delay the audio processing requiring short processing time is performed. As a delay control technique of conventional digital broadcast, for example, a broadcast receiver is proposed which measures the execution time of the video post-processing and delays the audio output by the measured execution time (see, for example, Patent Literature 1).

### Citation List

### Patent Literature

Patent Literature 1: Japanese Patent Laid-Open No. 2003-348489

However, in the conventional broadcast receiver, contents to be executed in the video post-processing and the audio post-processing are increased. Thus, depending on the received contents, the AV output data may not be generated in time for the PTS specified by the broadcast station. When the AV output data is not generated in time for the PTS, disturbances are generated in the video image and sound outputted on the screen and from the loudspeaker of the digital broadcast playing device, and thereby the AV quality of the terminal is deteriorated.

Further, the setting of the PTS, which determines the time from the TS reception timing to the AV output, is different for each broadcast station. Thus, depending on the broadcast station to be received, the generation of the AV output data may or may not be in time for the PTS.

Thus, in order to effect control to prevent the above described deterioration of the AV quality for all the broadcast stations, it is also possible to consider the delay control in which the AV output is performed by giving a margin to the decoding time of the playing device so that the AV output is performed at a timing delayed by a fixed time from the PTS specified by the broadcast station. However, with such delay control, the generation of the AV output data is not in time for the timing in some broadcast stations, and hence the AV output must be delayed until all the broadcast stations become able to perform the AV output.

### SUMMARY OF INVENTION

### Technical Problem

The present invention has been made under the above described background. An object of the present invention is to provide a digital broadcast playing device capable of performing control to suitably delay the output timing of digital broadcast.

### Solution to Problem

An aspect of the present invention provides a digital broadcast playing device which includes: a decode unit configured to decode received digital broadcast stream data to generate digital broadcast frame data and output specification time data of the digital broadcast frame; a delay time calculation unit configured to calculate a delay time by which the output-enabled time of the digital broadcast frame is delayed from the output specification time; a maximum delay time holding unit configured to hold, as maximum delay time, a maximum value of the delay time and the previously calculated delay time; and an output timing control unit configured to perform output timing control so that the digital broadcast frame is outputted after being delayed by the maximum delay time from the output specification time.

Another aspect of the present invention provides a digital broadcast playing method which includes: decoding received digital broadcast stream data to generate digital broadcast frame data and output specification time data of the digital broadcast frame; calculating a delay time by which the output-enabled time of the digital broadcast frame is delayed from the output specification time; holding, as maximum delay time, a maximum value of the delay time and the previously calculated delay time; and performing output timing control so that the digital broadcast frame is outputted after being delayed by the maximum delay time from the output specification time.

As will be described below, the present invention provides other aspects. Therefore, the disclosure of the present invention is intended to provide some of the aspects of the present invention and is not intended to limit the scope of the present invention described and claimed herein.

### BRIEF DESCRIPTION OF DRAWINGS

FIG. 1 is a block diagram showing a configuration of a digital broadcast playing device according to a first embodiment of the present invention.

FIG. 2 is a histogram showing a distribution of the time from the video stream reception to the video output.

FIG. 3 is a histogram showing a distribution of the time from the audio stream reception to the audio output.

FIG. 4 is a flow chart showing a flow of video output timing control in the first embodiment.

FIG. 5 is a flow chart showing a flow of audio output timing control in the first embodiment.

FIG. 6 is an illustration of update control of maximum delay time in the first embodiment.

FIG. 7 is a block diagram showing a configuration of a digital broadcast playing device according to a second embodiment of the present invention.

FIG. 8 is a flow chart showing a flow of video output timing control in the second embodiment.

FIG. 9 is a flow chart showing a flow of audio output timing control in the second embodiment.

### DESCRIPTION EMBODIMENTS

In the following, the present invention will be described in detail. However, the following description and the accompanying drawings do not limit the present invention. Instead, the scope of the present invention is defined by the appended claims.

In the following, a digital broadcast playing device according to an embodiment of the present invention will be described with reference to the accompanying drawings. The present embodiment exemplifies a digital broadcast playing device which is applied to a portable telephone capable of playing digital broadcast, such as one-segment broadcast and full-segment broadcast, a car navigation apparatus, and a digital television apparatus.

### First Embodiment

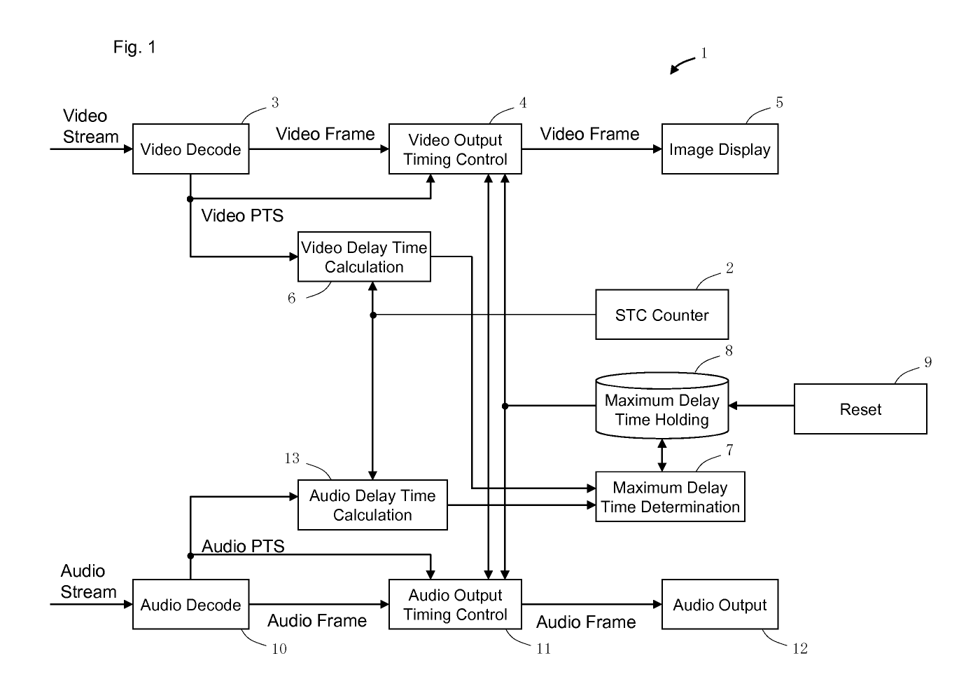

A digital broadcast playing device according to a first embodiment of the present invention will be described with reference to the accompanying drawings. Here, a configuration of the digital broadcast playing device according to the present embodiment will be first described. FIG. 1 is a block diagram showing a configuration of a digital broadcast playing device according to the present embodiment. As shown in FIG. 1, a digital broadcast playing device 1 includes a STC counter 2 which is a counter to generate a reference time (STC) used to play contents at a timing desired on the side of a broadcast station.

In the reception side digital broadcast playing device 1, the STC 2 is set based on a value inserted, as a PCR (Program Clock Reference), into a transport stream (TS) at a fixed interval by the broadcast station, and performs counting. That is, it can be said that the STC counter 2 is a counter by which the reference time intended on the side of the broadcast station is generated in the reception terminal.

As shown in FIG. 1, the digital broadcast playing device 1 includes, as a configuration to perform processing of the video stream (video PES) included in the stream of received digital broadcast, a video decode unit 3, a video output timing control unit 4, and an image display unit 5. Further, the digital broadcast playing device 1 includes, as a configuration to perform delay control of video output timing, a video delay time calculation unit 6, a maximum delay time determination unit 7, a maximum delay time holding unit 8, and a reset unit 9.

Further, as shown in FIG. 1, the digital broadcast playing device 1 includes, as a configuration to perform processing of the audio stream (audio PES) included in the stream of received digital broadcast, an audio decode unit 10, an audio output timing control unit 11, and an audio output unit 12. Further, the digital broadcast playing device 1 includes, as a configuration to perform delay control of audio output timing, an audio delay time calculation unit 13. In this case, the maximum delay time determination unit 7, the maximum delay time holding unit 8, and the reset unit 9 are used commonly in the processing of the video and audio streams.

The video decode unit 3 is a decoder of the video stream, such as H.264 and MPEG 2, specified by the digital broadcast. The data inputted into the video decode unit 3 is a video stream (video PES) in which the video PTS is associated with the stream of video frames to be decoded. The video decode unit 3 decodes the video stream to generate the video PTS and the video frame. Note that the video decode unit 3 may also perform processing, such as image quality enhancement processing of the generated video frame.

The video delay time calculation unit 6 calculates a delay time (video delay time) by which the time of the STC counter is delayed from the video PTS at the timing when the video decode unit 3 completes the processing for one frame. The data inputted into the video delay time calculation unit 6 are the video PTS from the video decode unit 3, and the time of the STC counter 2. In the video delay time calculation unit 6, the video delay time is calculated based on the following expression 1.

Video delay time=time of STC counter 2−video PTS (Expression 1)

The audio decode unit 10 is a decoder of the audio stream, such as AAC, specified by the digital broadcast. The data inputted into the audio decode unit 10 is an audio stream (audio PES) in which the audio PTS is associated with the stream of audio frames to be decoded. The audio decode unit 10 decodes the audio stream to generate the audio PTS and the audio frame. Note that the audio decode unit 10 may also perform processing, such as sound quality enhancement processing of the generated audio frame.

The audio delay time calculation unit 13 calculates a delay time (audio delay time) by which the time of the STC counter 2 is delayed from the audio PTS at the timing when the audio decode unit 10 completes the processing for one frame. The data inputted into the audio delay time calculation unit 13 are the audio PTS from the audio decode unit 10, and the time of the STC counter 2. In the audio delay time calculation unit 13, the audio delay time is calculated based on the following expression 2.

Audio delay time=time of STC counter 2−audio PTS (Expression 2)

The maximum delay time determination unit 7 determines a maximum value of the delay time from the PTS (video PTS and audio PTS) of the entire system. The data inputted into the maximum delay time determination unit 7 are the video delay time from the video delay time calculation unit 6, the audio delay time from the audio delay time calculation unit 13, and the maximum delay time currently held in the maximum delay time holding unit 8. The maximum delay time determination unit 7 selects a largest delay time (maximum delay time) among these data, and holds the selected delay time in the maximum delay time holding unit 8. Thereby, the maximum delay time is updated.

The maximum delay time holding unit 8 is configured by a memory, and the like, and holds the maximum delay time selected by the maximum delay time determination unit 7. That is, the maximum delay time holding unit 8 holds a maximum value (maximum delay time) among the times (delay times) at which the video frame and the audio frame are outputted after being respectively delayed from the PTSs (video PTS and audio PTS) respectively associated with the video frame and the audio frame. In this case, a predetermined upper limit value (upper limit delay time) is set for the maximum delay time.

The reset unit 9 has a function of resetting the value of the maximum delay time held in the maximum delay time holding unit 8 to an initial value (for example, 0 and the like). The resetting of the maximum delay time is performed when a broadcast station to be received is changed or when a digital broadcast content to be played is changed. Note that the initial value may only be a predetermined value (value defined beforehand), and is not limited to 0.

In the video output timing control unit 4, the delay control of the video output timing, for outputting a video frame to the image display unit 5, is performed at the timing which is delayed by the maximum delay time held in the maximum delay time holding unit 8 from the video PTS associated with the video frame. The data inputted into the video output timing control unit 4 are the video frame and the video PTS which are received from the video decode unit 3, the time of the STC counter 2, and the maximum delay time held in the maximum delay time holding unit 8. Note that the video output timing control unit 4 outputs the video frame to the image display unit 5, only when the following expression 3 is established.

Time of STC counter 2≧video PTS+maximum delay time (Expression 3)

The image display unit 5 has a function of displaying the video frame received from the video output timing control unit 4, and is configured, for example, by a liquid crystal display, and the like.

In the audio output timing control unit 11, the delay control of the audio output timing, for outputting an audio frame to the audio output unit 12, is performed at the timing which is delayed by the maximum delay time held in the maximum delay time holding unit 8 from the audio PTS associated with the audio frame. The data inputted into the audio output timing control unit 11 are the audio frame and the audio PTS which are received from the audio decode unit 10, the time of the STC counter 2, and the maximum delay time held in the maximum delay time holding unit 8. Note that the audio output timing control unit 11 outputs the audio frame to the audio output unit 12, only when the following expression 4 is established.

Time of STC counter 2≧audio PTS+maximum delay time (Expression 4)

The audio output unit 12 has a function of performing audio output of the audio frame received from the audio output timing control unit 11, and is configured, for example, by a loudspeaker, and the like.

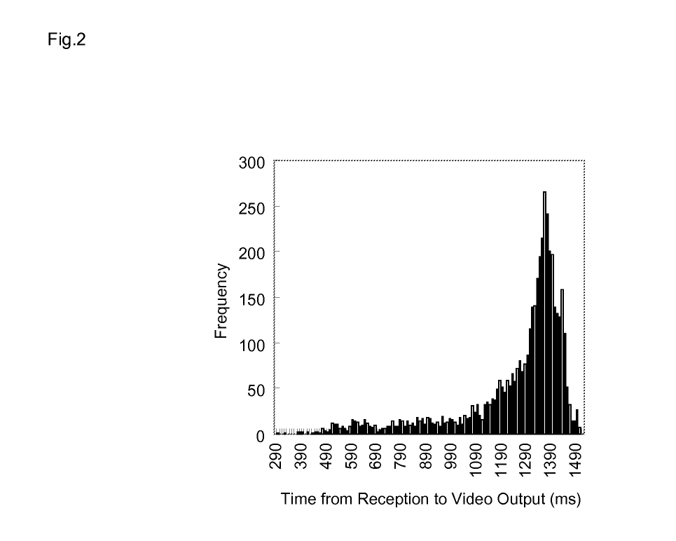

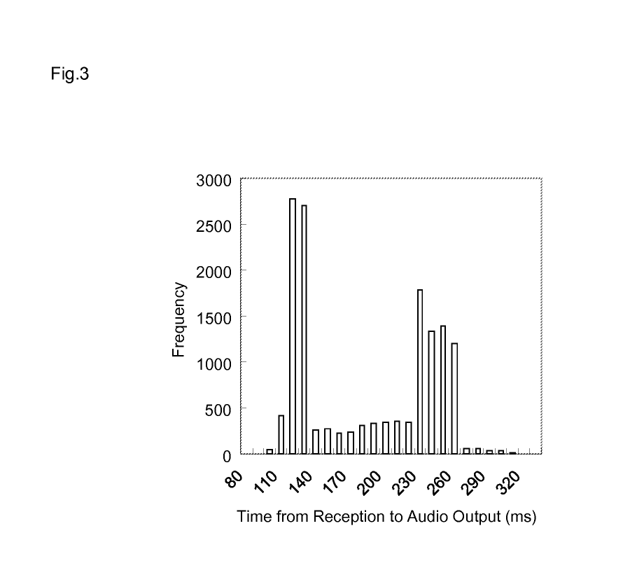

Next, the statistical distribution of the time from the reception of digital broadcast stream (a video stream and an audio stream) to the PTS will be described with reference to FIG. 2 and FIG. 3.

FIG. 2 is a histogram showing an example of distribution of the time difference from the video stream reception to the video output. As shown in FIG. 2, in this example, the time difference is mostly distributed in the range centered at about 1350 ms and extended from about 1100 ms to about 1500 ms. However, although less frequently, the time difference from the video stream reception to the video output also exists in the range from about 500 ms to about 1000 ms as shown in FIG. 2. The time difference of about 300 ms also exists in the distribution shown in FIG. 2. In this way, the time difference from the video stream reception to the video PTS is varied for each broadcast station.

FIG. 3 is a histogram showing an example of distribution of the time difference from the audio stream reception to the audio output. As shown in FIG. 3, in this example, a certain part of the distribution is concentrated in the range from about 130 ms to 140 ms, and a certain part of the distribution is also concentrated in the range from about 240 ms to about 280 ms. In this way, the time difference from the audio stream reception to the audio PTS is varied for each broadcast station.

An operation of the digital broadcast playing device 1 of the first embodiment, configured as described above, will be described with reference to the drawings.

The digital broadcast playing device 1 of the present embodiment is capable of performing suitable delay control of the output timing in the state where the time difference from the reception to the PTS is varied for each broadcast station as described above (see FIG. 2 and FIG. 3). In the following, the description will be given centering on the delay control of the output timing.

(Delay Control of Video Output Timing)

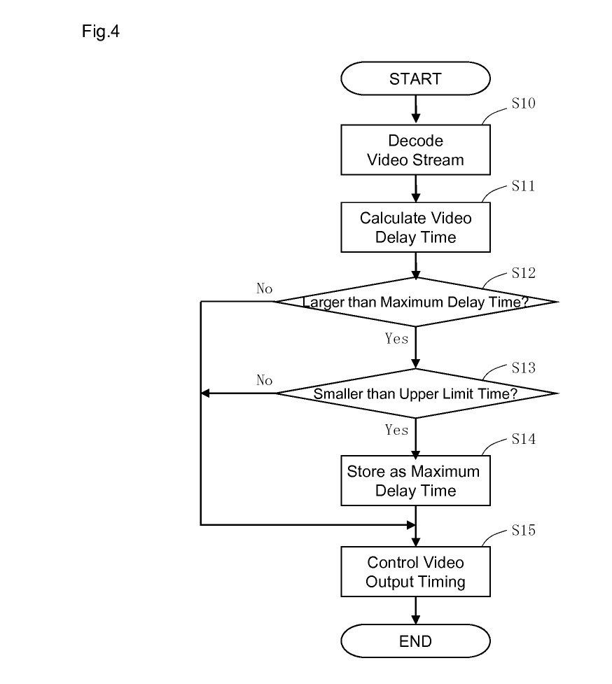

FIG. 4 is a flow chart showing a flow of the delay control of video output timing. As shown in FIG. 4, in the video decode unit 3, a video stream included in a stream of digital broadcast is first decoded, so that a video frame and a video PTS are generated (S10).

Next, in the video delay time calculation unit 6, the time (video delay time), by which the time of the STC counter 2 is delayed from the video PTS, is calculated (S11). Then, in the maximum delay time determination unit 7, whether the calculated video delay time is larger than the maximum delay time held in the maximum delay holding unit, and whether the calculated video delay time is smaller than the set upper limit delay time are determined (S12, S13).

When the video delay time is larger than the maximum delay time and is smaller than the upper limit delay time, the video delay time is held as a new maximum delay time (S14). That is, the maximum delay time is updated. Note that when the video delay time is not larger than the maximum delay time or when the video delay time is not smaller than the upper limit delay time, the maximum delay time is not updated.

Then, in the video output timing control unit 4, the delay control of video output timing is performed by using the maximum delay time (S15). In this case, the delay control to output the video frame to the image display unit 5 is performed at the timing which is delayed by the maximum delay time from the video PTS associated with the video frame.

(Delay Control of Audio Output Timing)

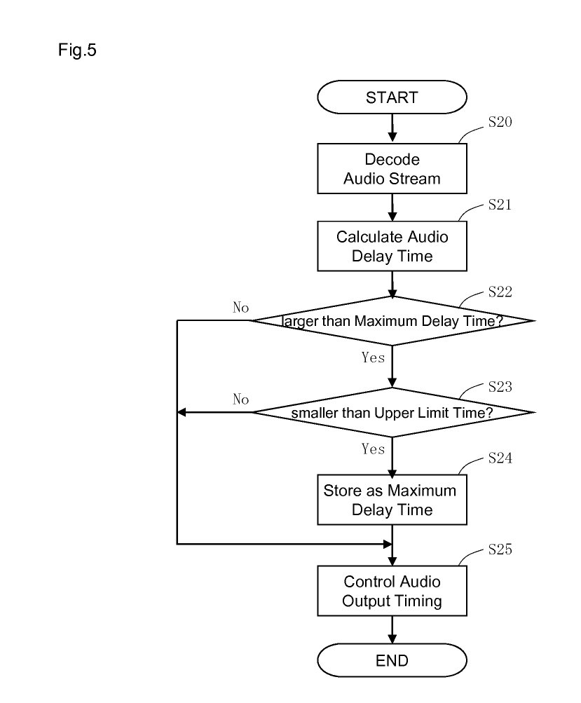

FIG. 5 is a flow chart showing a flow of the delay control of audio output timing. As shown in FIG. 5, in the audio decode unit 10, an audio stream included in the stream of digital broadcast is first decoded, so that an audio frame and an audio PTS are generated (S20).

Next, in the audio delay time calculation unit 13, the time (audio delay time), by which the time of the STC counter 2 is delayed from the audio PTS, is calculated (S21). Then, in the maximum delay time determination unit 7, whether the calculated audio delay time is larger than the maximum delay time held in the maximum delay holding unit, and whether the calculated audio delay time is smaller than the set upper limit delay time are determined (S22, S23).

When the audio delay time is larger than the maximum delay time and is smaller than the upper limit delay time, the audio delay time is held as a new maximum delay time (S24). That is, the maximum delay time is updated. Note that when the audio delay time is not larger than the maximum delay time or when the audio delay time is not smaller than the upper limit delay time, the maximum delay time is not updated.

Then, in the audio output timing control unit 11, the delay control of audio output timing is performed by using the maximum delay time (S25). In this case, in the audio output timing control unit 11, the delay control to output the audio frame to the audio output unit 12 is performed at the timing which is delayed by the maximum delay time from the audio PTS associated with the audio frame.

(Update Control of Maximum Delay Time)

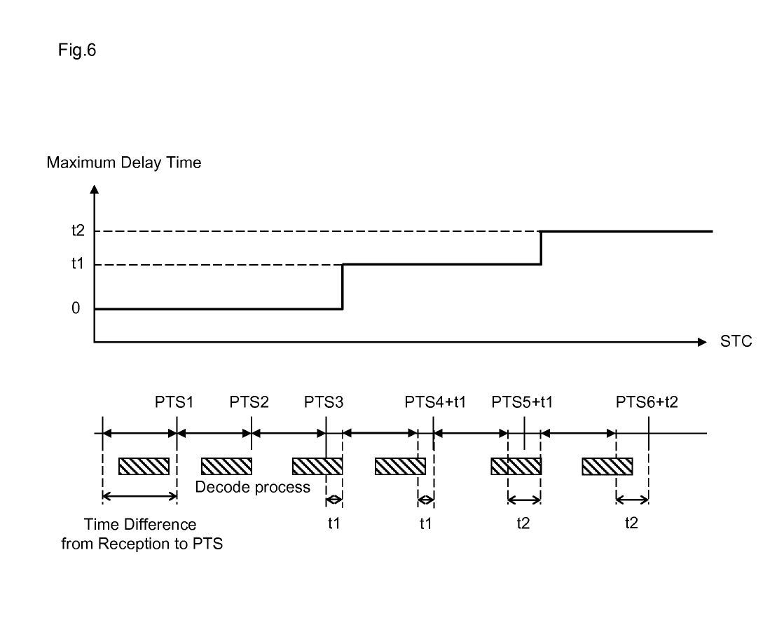

FIG. 6 is an illustration showing an example of the update control of the maximum delay time. In the graph of FIG. 6, the horizontal axis shows the reference time (STC) of the system, and the vertical axis shows the maximum delay time. Under the graph, a state is shown in which the decode processing (shown with oblique lines in the figure) of six streams (for example, video streams) is performed according to the flow of the reference time (STC).

In the example shown in FIG. 6, in the first stream immediately after a broadcast station is selected, decode processing is completed by the PTS1 (for example, the video PTS) specified for this stream, so as to be in time for the timing of the frame output. In the second stream data, the decode processing is similarly completed. Note that at this time, the maximum delay time held in the maximum delay time holding unit 8 is 0.

However, in the third stream, the decode processing is not completed by the PTS3 specified for this stream, and the timing of the frame output is delayed by t1 from the PTS3. Therefore, in this case, the maximum delay time held in the maximum delay time holding unit 8 is updated from 0 to t1.

Thereafter, in the fourth stream, the timing delayed by the maximum delay time t1 from the PTS4 specified for the stream becomes the frame output timing. In this case, although the decode processing is not completed by the PTS4 specified for the fourth stream, the decode processing is completed by the time (PTS4+t1) which is delayed by the maximum delay time t1 from the PTS4. Thus, the decode processing is completed in time for the frame output timing.

In the fifth stream, the decode processing is not completed by the time (PTS5+t1) which is delayed by the maximum delay time t1 from the PTS5 specified for this stream, and the frame output timing is delayed by t2 from the PTS5. Therefore, in this case, the maximum delay time held in the maximum delay time holding unit 8 is updated from t1 to t2.

In this way, in the example shown in FIG. 6, immediately after the broadcast station is selected, the delay time of the AV output is 0, and the AV output is performed at the timing of PTS. Thereafter, when a stream with a very short time from the reception to the PTS is received, the processing in the video decode unit 3 is not in time for the video PTS. Thus, the video delay time calculated in the video delay time calculation unit 6 is set in the maximum delay time holding unit 8 by the maximum delay time determination unit 7. Thereby, in the video output timing control unit 4 and the audio output timing control unit 11, the output timing is controlled so that the output is performed in AV synchronization which is achieved again based on the delay time newly set in the maximum delay time holding unit 8.

With the digital broadcast playing device 1 according to the first embodiment, it is possible to perform control to suitably delay the output timing of digital broadcast.

That is, in the present embodiment, a delay time is calculated when the output of a digital broadcast frame is not in time for an output specification time (PTS), and a maximum value (maximum delay time) of the delay time is held. Then, the delay control of the output timing of digital broadcast is performed by using the maximum delay time. Thereby, it is possible to perform control to suitably delay the output timing of digital broadcast.

For example, when the output of a video frame of digital broadcast is not in time for an output specification time (video PTS), a video delay time is calculated, and a maximum value (video maximum delay time) of the video delay time is held. Then, the delay control of the video output timing of the video frame is performed by using the video maximum delay time. Thereby, it is possible to perform control to suitably delay the video output timing of the video frame.

Alternatively, when the output of an audio frame of digital broadcast is not in time for an output specification time (audio PTS), an audio delay time is calculated, and a maximum value (audio maximum delay time) of the audio delay time is held. Then, the delay control of the audio output timing of the audio frame is performed by using the audio maximum delay time. Thereby, it is possible to perform control to suitably delay the audio output timing of the audio frame.

Further, in the present embodiment, the delay control of the output timing of digital broadcast is performed by using a maximum delay time commonly used for the video frame and the audio frame. Therefore, it is possible to perform control to suitably delay the output timing of digital broadcast in the state where the AV synchronization is established.

Further, in the present embodiment, when a broadcast station to be received or a digital broadcast content to be played is changed, the maximum delay time is reset to the initial value. Therefore, it is possible to perform control to suitably delay the output timing of digital broadcast for each broadcast station and each content.

Further, in the present embodiment, depending on the broadcast station and contents of digital broadcast, the delay time may become very large in rare cases. Even in such case, the maximum delay time is prevented from being excessively increased. Thus, it is possible to perform control to suitably delay the output timing of digital broadcast.

With the digital broadcast playing device 1 as described above, when the video output is not in time for the video PTS, it is possible to perform the control of AV output while suppressing the delay of the output in the entire system.

In this case, when the time until the received stream is decoded and outputted is delayed from the PTS, the delay time is held in the maximum delay time holding unit 8. The delay time (maximum delay time) held in the maximum delay time holding unit 8 is updated while it is checked whether a delay time larger than the maximum delay time is generated. Further, the output timing control unit performs control so that the stream is outputted after being delayed by the maximum delay time from the PTS. Thereby, in the entire system, the playing of the streams can be performed with a minimum delay from the PTS. Further, in this control, the delay time needs to be adjusted immediately after the selection of a broadcast station. However, in this control, the deterioration of the AV quality can be mostly prevented while the viewing and listening of the digital broadcast is continued for a long time.

Further, even when either the video output or the audio output is delayed, the delay is reflected in the maximum delay time which is commonly used in the system. Thereby, in the entire system, the playing of streams can be performed with a minimum delay time from the PTS while the AV synchronization is established.

Further, the reset unit 9 is provided which resets the maximum delay time holding unit 8 at the time when a broadcast station to be received or a content to be played is changed. Thereby, it is possible to perform the playing with a minimum delay time for each broadcast station and each content. Further, it is also possible to set beforehand a maximum delay time suitable for each broadcast station and each content when the maximum delay time holding unit 8 is reset. Thus, it is also possible to prevent the delay time adjustment processing from being generated immediately after the selection of a broadcast station.

Further, the maximum delay time determination unit 7 is provided which prevents the value of the maximum delay time held in the maximum delay time holding unit 8 from becoming equal to or larger than a predetermined value. Thereby, even in a rare case where the maximum delay time is increased to a very large value depending upon a content to be played, the playing can be performed without a significant increase of the delay time.

### Second Embodiment

Next, a digital broadcast playing device according to a second embodiment of the present invention will be described with reference to the drawings. Here, the configuration of the digital broadcast playing device according to the present embodiment will be described focusing on points different from the first embodiment. That is, unless specifically referred to, the configuration of the digital broadcast playing device according to the present embodiment is the same as the configuration of the first embodiment.

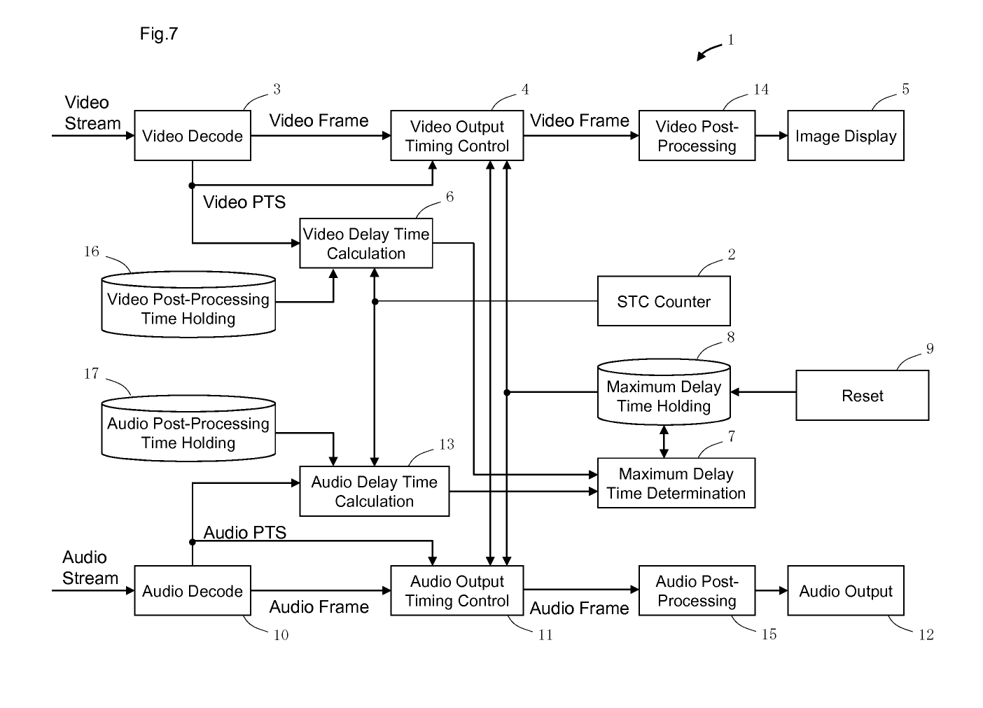

FIG. 7 is a block diagram showing a configuration of a digital broadcast playing device according to the present embodiment. As shown in FIG. 7, the digital broadcast playing device 1 includes a video post-processing unit 14 and an audio post-processing unit 15 as a configuration for performing predetermined post-processing after the output timing control. Further, the digital broadcast playing device 1 includes a video post-processing time holding unit 16 and an audio post-processing time holding unit 17 as a configuration for performing the delay control of output timing in consideration of the post-processing.

The video post-processing unit 14 performs post-processing, such as image quality enhancement processing of a video frame. The video post-processing unit 14 is provided between the video output timing control unit 4 and the image display unit 5. That is, the video post-processing here means the post-processing performed in the subsequent stage of the video output timing control.

The audio post-processing unit 15 performs post-processing, such as sound quality enhancement processing of an audio frame. The audio post-processing unit 15 is provided between the audio output timing control unit 11 and the audio output unit 12. That is, the audio post-processing here means post-processing performed in the subsequent stage of the audio output timing control.

Each of the video post-processing time holding unit 16 and the audio post-processing time holding unit 17 is configured by a memory, and the like. In the video post-processing time holding unit 16, the time (video post-processing time) required for the post-processing in the video post-processing unit 14 is held. In the audio post-processing time holding unit 17, the time (audio post-processing time) required for the post-processing in the audio post-processing unit 15 is held.

The video delay time calculation unit 6 calculates a delay time (video delay time) by which the time of the STC counter 2 is delayed from the video PTS at the timing when the video post-processing time elapses after the completion of the processing for one frame by the video decode unit 3. The data inputted into the video delay time calculation unit 6 are the video PTS from the video decode unit 3, the video post-processing time, and the time of the STC counter 2. In the video delay time calculation unit 6, the video delay time is calculated based on the following expression (5).

Video delay time=time of STC counter 2+video post-processing time−video PTS (Expression 5)

The audio delay time calculation unit 13 calculates a delay time (audio delay time) by which the time of the STC counter 2 is delayed from the audio PTS at the timing when the audio post-processing time elapses after the completion of the processing for one frame by the audio decode unit 10. The data inputted into the audio delay time calculation unit 13 are the audio PTS from the audio decode unit 10, the audio post-processing time, and the time of the STC counter 2. In the audio delay time calculation unit 13, the audio delay time is calculated based on the following expression (6).

Audio delay time=time of STC counter 2+audio post-processing time−audio PTS (Expression 6)

An operation of the digital broadcast playing device 1 according to the second embodiment, configured as described above, will be described with reference to the drawings. Here, the description is given centering on the delay control of output timing in consideration of the post-processing time.

(Delay Control of Video Output Timing in Consideration of Video Post-Processing Time)

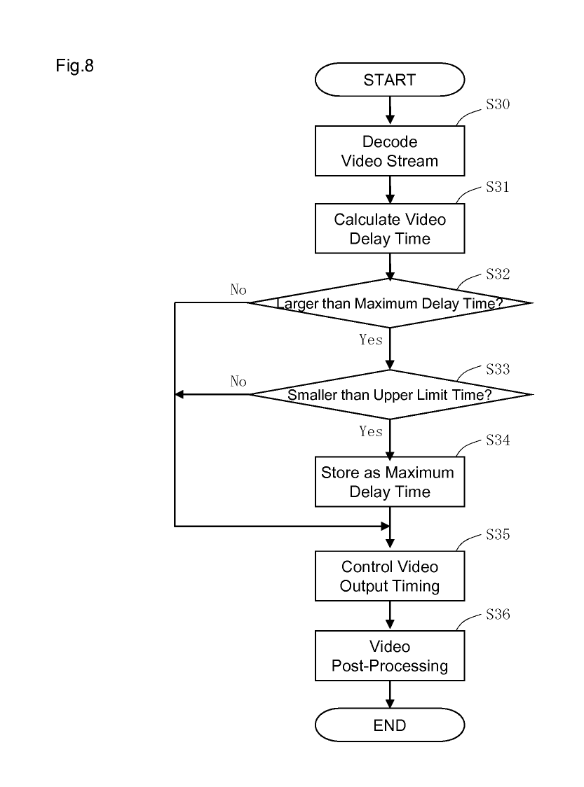

FIG. 8 is a flow chart showing a flow of the delay control of video output timing in consideration of the video post-processing time. As shown in FIG. 8, in the video decode unit 3, a video stream included in a stream of digital broadcast is first decoded, so that a video frame and a video PTS are generated (S30).

Next, in the video delay time calculation unit 6, a delay time (video delay time), by which the time of the STC counter 2 after video post-processing is delayed from the video PTS, is calculated (S31). Then, in the maximum delay time determination unit 7, whether the calculated video delay time is larger than the maximum delay time held in the maximum delay time holding unit, and whether the calculated video delay time is smaller than the set upper limit delay time are determined (S32, S33).

When the video delay time is larger than the maximum delay time and is smaller than the upper limit delay time, the video delay time is held as a new maximum delay time (S34). That is, the maximum delay time is updated. Note that when the video delay time is not larger than the maximum delay time, or when the video delay time is not smaller than the upper limit delay time, the maximum delay time is not updated.

Subsequently, in the video output timing control unit 4, the delay control of video output timing is performed by using the maximum delay time (S35). In this case, the delay control is performed to output the video frame to the video post-processing unit 14 at the timing which is delayed by the maximum delay time from the video PTS associated with the video frame. Then, in the video post-processing unit 14, post-processing, such as image quality enhancement processing, is applied to the video frame outputted from the video output timing control unit 4 (S36), and thereafter the video frame subjected to the post-processing is outputted to an image output unit.

(Delay Control of Audio Output Timing in Consideration of Audio Post-Processing Time)

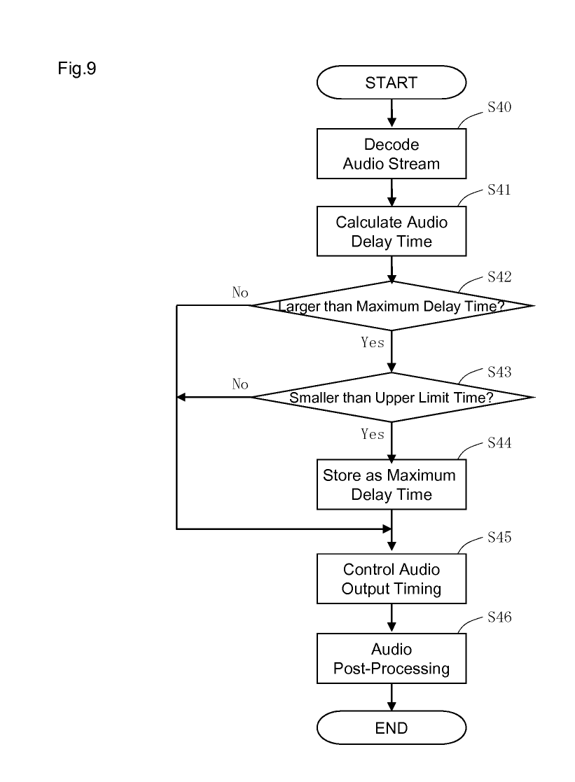

FIG. 9 is a flow chart showing a flow of the delay control of audio output timing in consideration of the audio post-processing time. As shown in FIG. 9, in the audio decode unit 10, an audio stream included in a stream of digital broadcast is decoded, so that an audio frame and an audio PTS are generated (S40).

Next, in the audio delay time calculation unit 13, a delay time (audio delay time), by which the time of the STC counter 2 after the audio post-processing is delayed from the audio PTS, is calculated (S41). Then, in the maximum delay time determination unit 7, whether the calculated audio delay time is larger than the maximum delay time held in the maximum delay time holding unit, and whether the calculated audio delay time is smaller than the set upper limit delay time are determined (S42, S43).

When the calculated audio delay time is larger than the maximum delay time and is smaller than the upper limit delay time, the calculated audio delay time is held as a new maximum delay time (S44). That is, the maximum delay time is updated. Note that when the calculated audio delay time is not larger than the maximum delay time, or when the calculated audio delay time is not smaller than the upper limit delay time, the maximum delay time is not updated.

Subsequently, in the audio output timing control unit 11, the delay control of audio output timing is performed by using the maximum delay time (S45). In this case, the delay control is performed to output the audio frame to the audio post-processing unit 15 at the timing which is delayed by the maximum delay time from the audio PTS associated with the audio frame. Then, in the audio post-processing unit 15, post-processing, such as sound quality enhancement processing, is applied to the audio frame outputted from the audio output timing control unit 11 (S46), and thereafter the audio frame subjected to the post-processing is outputted to an audio output unit 12.

Even with the digital broadcast playing device 1 according to the second embodiment configured in this way, it is possible to obtain the same operation effect as the first embodiment.

Further, in the present embodiment, when the post-processing is performed after the output timing control, it is possible to perform control to suitably delay the output timing of digital broadcast in consideration of the time (post-processing time) required for the post-processing.

For example, when the post-processing (image processing) is performed to a video frame after the video output timing control, it is possible to perform control to suitably delay the video output timing of the video frame in consideration of the time (video post-processing time) required for the post-processing.

Alternatively, when the post-processing (audio processing) is performed to an audio frame after the audio output timing control, it is possible to perform control to suitably delay the audio output timing of the audio frame in consideration of the time (audio post-processing time) required for the post-processing.

With the digital broadcast playing device 1 configured as described above, even when the video post-processing and the audio post-processing having different processing times are generated after the timing to control the AV synchronization, it is possible to control and suppress the output delay in the entire system, while eventually securing the AV synchronization.

For example, when the video post-processing is performed after the video output timing control, it is possible to play the stream with a minimum delay time from the PTS in the entire system, in consideration of the video post-processing time.

Alternatively, when the audio post-processing is performed after the audio output timing control, it is possible to play the stream with a minimum delay time from the PTS in the entire system, in consideration of the audio post-processing time.

In the above, the embodiments according to the present invention have been exemplarily described, but the scope of the present invention is not limited to these. The present invention may be changed and modified according to the purpose within the scope described in the appended claims.

A digital broadcast playing device according to the present invention has a configuration including: a decode unit configured to decode received digital broadcast stream data to generate digital broadcast frame data and output specification time data of the digital broadcast frame; a delay time calculation unit configured to calculate a delay time by which the output-enabled time of the digital broadcast frame is delayed from the output specification time; a maximum delay time holding unit configured to hold, as maximum delay time, a maximum value of the delay time and the previously calculated delay time; and an output timing control unit configured to perform output timing control so that the digital broadcast frame is outputted after being delayed by the maximum delay time from the output specification time.

With the digital broadcast playing device, when the output of the digital broadcast frame is not in time for the output specification time (PTS), the delay time of the output of the digital broadcast frame from the output specification time is calculated, and a maximum value (maximum delay time) of the delay time is held. Then, the delay control of the output timing of the digital broadcast is performed by using the maximum delay time. Thereby, it is possible to perform control to suitably delay the output timing of the digital broadcast.

Further, the digital broadcast playing device according to the present invention is configured such that the decode unit includes a video decode unit which decodes video stream data included in the digital broadcast stream data to generate video frame data and video output specification time data of the video frame, such that the delay time calculation unit includes a video delay time calculation unit which calculates, as video delay time, a delay time by which the video output-enabled time of the video frame is delayed from the video output specification time, such that the maximum delay time holding unit holds, as video maximum delay time, a maximum value of the video delay time and the previously calculated video delay time, and such that the output timing control unit includes a video output timing control unit which performs the control of video output timing so that the video frame is outputted after being delayed by the video maximum delay time from the video output specification time.

With this configuration, when the output of the video frame of the digital broadcast is not in time for the output specification time (video PTS), the video delay time is calculated, and a maximum value (video maximum delay time) of the video delay time is held. Then, the delay control of the video output timing of the video frame is performed by using the video maximum delay time. Thereby, it is possible to perform control to suitably delay the video output timing of the video frame.

Further, the digital broadcast playing device according to the present invention is configured such that the decode unit includes an audio decode unit which decodes audio stream data included in the digital broadcast stream data to generate audio frame data and audio output specification time data of the audio frame, such that the delay time calculation unit includes an audio delay time calculation unit which calculates, as audio delay time, a delay time by which the audio output-enabled time of the audio frame is delayed from the audio output specification time, such that the maximum delay time holding unit holds, as audio maximum delay time, a maximum value of the audio delay time and the previously calculated audio delay time, and such that the output timing control unit includes an audio output timing control unit which performs the control of audio output timing so that the audio frame is outputted after being delayed by the audio maximum delay time from the audio output specification time.

With this configuration, when the output of the audio frame of the digital broadcast is not in time for the output specification time (audio PTS), the audio delay time is calculated, and a maximum value (audio maximum delay time) of the audio delay time is held. Then, the delay control of the audio output timing of the audio frame is performed by using the audio maximum delay time. Thereby, it is possible to perform control to suitably delay the audio output timing of the audio frame.

Further, in the digital broadcast playing device according to the present invention, the maximum delay time holding unit holds the value of the larger one of the video maximum delay time and the audio maximum delay time as the maximum delay time commonly used for the video frame and the audio frame.

With this configuration, the delay control of the output timing of the digital broadcast is performed by using the maximum delay time commonly used for the video frame and the audio frame. Therefore, it is possible to perform control to suitably delay the output timing of the digital broadcast while securing the AV synchronization.

Further, the digital broadcast playing device according to the present invention is configured by further including: a post-processing unit which applies predetermined post-processing to a digital broadcast frame outputted from the output timing control unit; and a post-processing time holding unit which holds, as post-processing time, a time required for the post-processing, and is configured such that the delay time calculation unit calculates a delay time based on the post-processing time.

With this configuration, when the post-processing is performed after the output timing control, it is possible to perform control to suitably delay the output timing of the digital broadcast in consideration of the time (post-processing time) required for the post-processing.

Further, the digital broadcast playing device according to the present invention is configured such that the post-processing unit includes a video post-processing unit which applies, as the post-processing, predetermined image processing to the video frame outputted from the video output timing control unit, such that the post-processing time holding unit includes a video post-processing time holding unit which holds, as video post-processing time, a time required for the image processing, and such that the video delay time calculation unit calculates the video delay time by adding the video post-processing time to the video output-enabled time of the video frame.

With this configuration, when the post-processing (image processing) is applied to the video frame after the video output timing control, it is possible to perform control to suitably delay the video output timing of the video frame in consideration of the time (video post-processing time) required for the post-processing.

Further, the digital broadcast playing device according to the present invention is configured such that the post-processing unit includes an audio post-processing unit which applies, as the post-processing, predetermined audio processing to the audio frame outputted from the audio output timing control unit, such that the post-processing time holding unit includes an audio post-processing time holding unit which holds, as audio post-processing time, a time required for the audio processing, and such that the audio delay time calculation unit calculates the audio delay time by adding the audio post-processing time to the audio output-enabled time of the audio frame.

With this configuration, when the post-processing (audio processing) is applied to the audio frame after the audio output timing control, it is possible to perform control to suitably delay the audio output timing of the audio frame in consideration of the time (audio post-processing time) required for the post-processing.

Further, the digital broadcast playing device according to the present invention has a configuration including a reset unit which resets the maximum delay time to a predetermined initial value based on the change of a broadcast station to be received or the change of a digital broadcast content to be played.

With this configuration, when the broadcast station to be received or the digital broadcast content to be played is changed, the maximum delay time is reset to the initial value. Therefore, it is possible to perform control to suitably delay the output timing of the digital broadcast for each broadcast station and each content of digital broadcast.

Further, in the digital broadcast playing device according to the present invention, the maximum delay time is limited to become smaller than a predetermined upper limit delay time.

The delay time may become very large depending on a broadcast station and a content of digital broadcast. However, with this configuration, even in such case, the maximum delay time can be prevented from being excessively increased. Thus, it is possible to perform control to suitably delay the output timing of the digital broadcast.

The digital broadcast playing method according to the present invention includes: decoding received digital broadcast stream data to generate digital broadcast frame data and output specification time data of the digital broadcast frame; calculating a delay time by which the output-enabled time of the digital broadcast frame is delayed from the output specification time; holding, as maximum delay time, a maximum value of the delay time and the previously calculated delay time; and performing output timing control so that the digital broadcast frame is outputted after being delayed by the maximum delay time from the output specification time.

With this method, when the output of the digital broadcast frame is not in time for the output specification time (PTS), the delay time is calculated and a maximum value (maximum delay time) of the delay time is held. Further, the delay control of the output timing of the digital broadcast is performed by using the maximum delay time. Thereby, it is possible to perform control to suitably delay the output timing of the digital broadcast.

In the above, the embodiments of the present invention conceivable at present have been described. However, it will be understood that various modifications of the present embodiments are possible, and that all the modifications within the spirit and scope of the present invention are intended to be included in the scope of the appended claims.

### INDUSTRIAL APPLICABILITY

As described above, the digital broadcast playing device according to the present invention has an effect of capable of performing control to suitably delay the output timing of digital broadcast, and hence is useful for use in a portable telephone capable of playing digital broadcast, such as one-segment broadcast and full-segment broadcast, a car navigation apparatus, and a digital television apparatus.

### REFERENCE SIGNS LIST

1 Digital broadcast playing device
2 STC counter
3 Video decode unit
4 Video output timing control unit
5 Image display unit
6 Video delay time calculation unit
7 Maximum delay time determination unit
8 Maximum delay time holding unit
9 Reset unit
10 Audio decode unit
11 Audio output timing control unit
12 Audio output unit
13 Audio delay time calculation unit
14 Video post-processing unit
15 Audio post-processing unit
16 Video post-processing time holding unit
17 Audio post-processing time holding unit

1. A digital broadcast playing device comprising:
a decode unit which decodes received digital broadcast stream data to generate digital broadcast frame data and output specification time data of the digital broadcast frame;
a delay time calculation unit which calculates a delay time by which the output-enabled time of the digital broadcast frame is delayed from the output specification time;
a maximum delay time holding unit which holds, as maximum delay time, a maximum value of the delay time and the previously calculated delay time; and
an output timing control unit which performs output timing control so that the digital broadcast frame is outputted after being delayed by the maximum delay time from the output specification time.

2. The digital broadcast playing device according to claim 1,
wherein the decode unit includes a video decode unit which decodes video stream data included in the digital broadcast stream data to generate video frame data and video output specification time data of the video frame,
wherein the delay time calculation unit includes a video delay time calculation unit which calculates, as video delay time, a delay time by which the video output-enabled time of the video frame is delayed from the video output specification time,
wherein the maximum delay time holding unit holds, as video maximum delay time, a maximum value of the video delay time and the previously calculated video delay time, and
wherein the output timing control unit includes a video output timing control unit which controls the video output timing so that the video frame is outputted after being delayed by the video maximum delay time from the video output specification time.

3. The digital broadcast playing device according to claim 1,
wherein the decode unit includes an audio decode unit which decodes audio stream data included in the digital broadcast stream data to generate audio frame data and audio output specification time data of the audio frame,
wherein the delay time calculation unit includes an audio delay time calculation unit which calculates, as audio delay time, a delay time by which the audio output-enabled time of the audio frame is delayed from the audio output specification time,
wherein the maximum delay time holding unit holds, as audio maximum delay time, a maximum value of the audio delay time and the previously calculated audio delay time, and
wherein the output timing control unit includes an audio output timing control unit which controls the audio output timing so that the audio frame is outputted after being delayed by the audio maximum delay time from the audio output specification time.

4. The digital broadcast playing device according to claim 1,
wherein the decode unit includes a video decode unit which decodes video stream data included in the digital broadcast stream data to generate video frame data and video output specification time data of the video frame, and
an audio decode unit which decodes audio stream data included in the digital broadcast stream data to generate audio frame data and output specification time data of the audio frame,
wherein the delay time calculation unit includes a video delay time calculation unit which calculates, as video delay time, a delay time by which the video output-enabled time of the video frame is delayed from the video output specification time, and
an audio delay time calculation unit which calculates, as audio delay time, a delay time by which the audio output-enabled time of the audio frame is delayed from the audio output specification time,
wherein the maximum delay time holding unit holds, as maximum delay time commonly used for the video frame and the audio frame, the larger value of the video maximum delay time that is a maximum value of the video delay time and the previously calculated video delay time, and the audio maximum delay time that is a maximum value of the audio delay time and the previously calculated audio delay time, and
wherein the output timing control unit includes a video output timing control unit which controls the video output timing so that the video frame is outputted after being delayed by the common maximum delay time from the video output specification time, and
an audio output timing control unit which controls the audio output timing so that the audio frame is outputted after being delayed by the common maximum delay time from the audio output specification time.

5. The digital broadcast playing device according to claim 4, further comprising:
a post-processing unit which applies predetermined post-processing to the digital broadcast frame outputted from the output timing control unit; and
a post-processing time holding unit which holds, as post-processing time, the time required for the post-processing,
wherein the delay time calculation unit calculates the delay time based on the post-processing time.

6. The digital broadcast playing device according to claim 5,
wherein the post-processing unit includes a video post-processing unit which applies, as post-processing, predetermined image processing to the video frame outputted from the video output timing control unit,
wherein the post-processing time holding unit includes a video post-processing time holding unit which holds, video post-processing time, the time required for the image processing, and
wherein the video delay time calculation unit calculates the video delay time by adding the video post-processing time to the video output-enabled time of the video frame.

7. The digital broadcast playing device according to claim 5,
wherein the post-processing unit includes an audio post-processing unit which applies, as post-processing, predetermined audio processing to the audio frame outputted from the audio output timing control unit,
wherein the post-processing time holding unit includes an audio post-processing time holding unit which holds, as audio post-processing time, the time required for the audio processing, and
wherein the audio delay time calculation unit calculates the audio delay time by adding the audio post-processing time to the audio output-enabled time of the audio frame.

8. The digital broadcast playing device according to claim 1, further comprising a reset unit which resets the maximum delay time to a predetermined initial value based on the change of a broadcast station to be received or the change of a digital broadcast content to be played.

9. The digital broadcast playing device according to claim 1, wherein the maximum delay time is limited so as to be smaller than a predetermined upper limit delay time.

10. A digital broadcast playing method, comprising:
decoding received digital broadcast stream data to generate digital broadcast frame data and output specification time data of the digital broadcast frame;
calculating a delay time by which the output-enabled time of the digital broadcast frame is delayed from the output specification time;
holding, as maximum delay time, a maximum value of the delay time and the previously calculated delay time; and
performing output timing control so that the digital broadcast frame is outputted after being delayed by the maximum delay time from the output specification time.
